(19) United States
(12) Patent Application Publication
(10) Pub. No.: US 2003/0118186 A1
(43) Pub. Date: Jun. 26, 2003

(54) Apparatus for and method for cipher check of an analog scrambler

(76) Inventor: James E. Gilley, Lincoln, NE (US)

Correspondence Address: MCKEE, VOORHEES & SEASE, P.L.C., 801 GRAND AVENUE, SUITE 3200, DES MOINES, IA, 50309-2721, US

(21) Appl. No.: 10/308,800

(22) Filed: Dec. 2, 2002

Related U.S. Application Data
(63) Continuation of application No. 08/961,562, filed on Oct. 30, 1997.

(51) Int. Cl. H04L 9/00

(52) U.S. Cl. 380/268

(57) ABSTRACT

An apparatus and method for allowing an analog scrambler using an internal digital cipher to generate a pseudo-random number stream to drive the scrambling of the analog signal to be cipher checked, to add strength to the generation of the pseudo-random number stream, and/or to allow either analog scrambling of analog signals or digital encryption of digital signals. Digital connections are made directly to internal digital cipher to allow the foregoing functions.

### BACKGROUND OF THE INVENTION

1. Field of the Invention

The invention relates to verifying the correct implementation and operation of a cipher used in secure communications, otherwise called a cipher check, and in particular, to an apparatus and method for cipher check of a digital cipher driving an analog scrambler.

2. Problems in the Art

Many communications systems transmit audio or video information in an analog form. The content of the audio or video is contained within an analog waveform that is modulated on another analog waveform. The receiver simply separates the carrier wave from the wave containing the audio or video content, and the content can be played or displayed on appropriate equipment.

It is possible, however, for either intentional or unintentional eavesdroppers to rather easily derive the content of the communication. Methods have been developed to attempt to secure such communications.

Scrambling is one such method. The analog waveform containing the content of the communication is manipulated. The content is not discernible or intelligible without knowing how the waveform was manipulated and without the wherewithal to reconstruct the original analog waveform with that knowledge.

Many types of analog scramblers manipulate the analog waveform according to a pseudo random number stream (PRN). The transmitter and receiver(s) both know the pseudo random number stream and thus can synchronize to that stream so that the receiver(s) can descramble the waveform.

There are different types of pseudo random number generation. Pseudo random means that there is some reproducible method of number generation (as opposed to truly random numbers). However, the more the PRN stream looks like a random number stream, the more secure the PRN stream is, and thus the more secure the scrambling would be.

Some of the most secure pseudo random number generators (PRNGs) are digital ciphers. An example is the use of the Data Encryption Standard (DES) as a PRNG. It utilizes a secret key known only to the transmitter and receiver(s) and can have a very long overall cycle time, which means that it is impractical to reverse engineer the PRN stream with known processing equipment. The output of DES is a very secure pseudo random number stream. The analog information is thus essentially the “plain text” that is logically combined with the PRN stream to create the “cipher text” for the device.

Therefore, there are demonstrable advantages to implementing a digital cipher, as a PRNG, in an analog Scrambler. However, there are times when a digital cipher malfunctions, or appears to malfunction. There are also times when ode simply needs to verify that the digital cipher is operating correctly. Verification that a cipher is correctly implemented is commonly referred to as a cipher check. Cryptographic systems which operate strictly in the digital realm inherently have the ability to be cipher checked. A cipher check is usually performed by inserting a predetermined key into a cipher, and then using this cipher to encrypt some predetermined plaintext. The resulting ciphertext is then compared to that from a device which is known to be working properly. If the ciphertexts match, then the cipher check has succeeded. Digital cryptographic equipment may be easily cipher checked, since the plaintext is generally binary, in which case one may simply compare ciphertext bits. However, there is no known analog cryptographic system that can be cipher checked. Since both the plaintext and ciphertext are analog, it is extraordinarily difficult to cipher check an analog scrambler. This is because analog signals are impossible to specify precisely, due to noise, quantization errors, etc.

The invention solves the problem of allowing a cipher check to be performed on an analog scrambler. The Transcrypt SC20-460 analog rolling-code frequency inversion scrambler is an example of an analog scrambling device that is presently available.

A prior art example of an analog scrambler which makes use of a digital cipher is the Transcrypt SC20-460, which uses a cipher as a source of cryptographically secure pseudo-random numbers. This stream of pseudo-random numbers then drives the analog scrambling algorithm which allows analog audio to be encrypted or decrypted.

Therefore, there is a real need in the art for a way to cipher check a digital cipher used in an analog scrambler. It is therefore a principle object of the present invention to provide an apparatus and method for a cipher check of a digital cipher in an analog scrambler.

Further objects, features and advantages of the present invention relate to providing an apparatus and method as above described which:

(a) allows a cipher check to be performed on an analog scrambler;

(b) allows an analog scrambler to be certified to a standard;

(c) allows the ability to enhance security by adding a cipher external to the scrambler; and

(d) allows the ability to use the analog scrambler alternatively as a digital encryption device if desired.

These and other objects, features and advantages of the present invention will become more apparent with reference to the accompanying specification and claims.

### SUMMARY OF THE INVENTION

The present invention includes an apparatus and method for performing a cipher check on an analog scrambler utilizing a digital block cipher to generate a pseudo-random number bit stream to drive the analog scrambler. The block cipher can be implemented in software in a digital signal processor in the scrambler. Digital input and output leads are connected from external of the apparatus to the digital signal processor. By known means, the block cipher can then be digitally tested.

Optionally, the apparatus includes a second digital cipher connectable through the digital input and output leads, to allow a different or higher level of security of the pseudo-random number stream. Furthermore, optionally, the apparatus can be used as an analog scrambler and/or a digital encryptor. Also, the digital leads allow the cipher to be certified.

The method includes accessing the cipher directly from external to the scrambler. Its operation can be evaluated (cipher checked), digital encryption can occur in an analog scrambler, and additional levels of security can be added.

### BRIEF DESCRIPTION OF THE DRAWINGS

FIG. 1 is a block diagram depiction of an analog scrambler including connections to a digital signal processor which contains in software a digital block cipher which functions as a pseudo-random number generator, according to a preferred embodiment of the present invention.

### DETAILED DESCRIPTION OF PREFERRED EMBODIMENTS

Overview

To assist in a better understanding of the invention, a description of one embodiment or form the invention can take will now be set forth in detail. Frequent reference will be taken to the drawings. Reference numbers will sometimes be utilized to indicate certain parts or locations in the drawings. The same reference numbers will be used to indicate the same parts and locations throughout the drawings unless otherwise indicated.

This description will be in the context of an analog scrambler device to scramble audio or video.

Structure of Preferred Embodiment

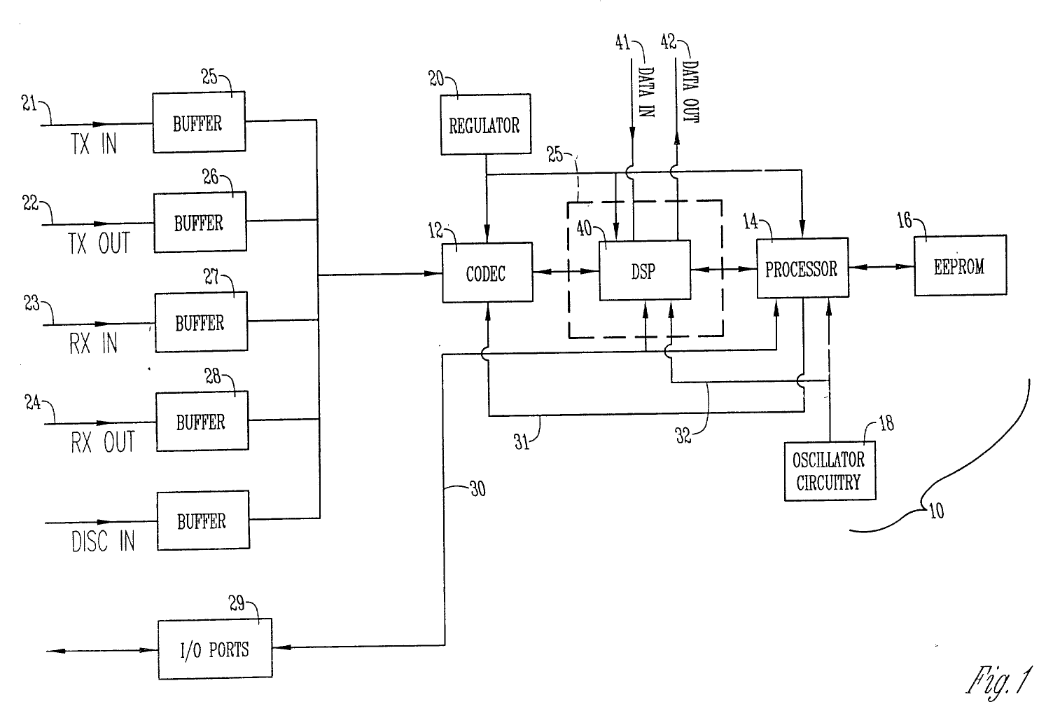

FIG. 1 illustrates an analog scrambler 10. The basic structure of scrambler 10 (e.g. Transcrypt International SC20-460) includes a coder/decoder (codec) 12 which, as is well known in the art, operates to code an analog waveform by sampling discrete parts of the waveform and then characterizing them digitally. Conversely codec 12 can take digitally characterizations of an analog waveform and reconstruct the waveform.

Codec 12 is controlled by a processor 14 that utilizes EEPROM 16, oscillator 18, and regulator 20 in conventional ways. Input and output to codec 12 is through lines 21, 22, 23, 24 and buffers 25, 26, 27, 28. Processor 14 communicates with I/O ports 29 and with a digital signal processor 40 (DSP 40) via bus 30. Processor 14 also communicates with codec 12 directly over line 31, and oscillator 18 does the same over line 32 with DSP 10 and processor 14.

DSP 40 performs the function of a PRNG to provide a secure PRN stream which is used to drive the analog scrambling. All this is conventional.

The invention is a modification to analog scrambler 10 which allows external access to the cipher in DSP 40 for the purposes of performing a cipher check. In order to do this, analog scrambler 10, which includes a digital cipher internally (as a pseudo-random number generator (PRNG)), is modified so that in addition to the analog inputs 21/23 and outputs 22/24, there is included a digital input (DATA-IN 41) and digital output (DATA-OUT 42), which allow direct access the cipher within DSP 40 of the analog scrambler 10. In this way, digital plaintext bits can be entered, and digital ciphertext bits that have been encrypted by the cipher are received. Given that there is also a way to load a crypto-variable (i.e. secret key), analog scrambler 10 can be cipher checked in a manner very similar to that which might be used to cipher check a digital cryptographic system. The new digital connections 41/42 to scrambler 10 can be used for the purposes of performing a cipher check. They also can be used to enter any plaintext bit stream desired while scrambler 10 is operating. Scrambler 10 will encrypt this plaintext digital bit stream, and use the resulting digital ciphertext to drive the analog scrambling process, which will affect the way the analog plaintext is converted to analog ciphertext. In this way, the security of the scrambler is enhanced by the ability to add another digital cipher (not shown) external to analog scrambler 10. One possible reason it may be wished to do this is if the security of the cipher being used by the analog scrambler is not trusted, and it is desired to conveniently substitute a different trusted cipher.

A further benefit of the invention is it allows analog scrambler 10 to be used as a digital encryption device if need be. This is because new digital connections 41/42 provide a path to enter and extract digital plaintext and ciphertext, making use of the cipher embedded in the scrambler to perform the encryption or decryption. Thus analog scrambler 10 becomes analog scrambler and/or digital encryptor 10.

A still further benefit of the invention is that it will allow the cipher embedded in DSP 40 of analog scrambler 10 to be certified to a standard. Certification is a process whereby an independent test lab performs a cipher check on a cryptographic device to insure that the cipher has been properly implemented and is free from mistakes. No analog scramblers have ever been capable of being certified in the past.

The preferred embodiment can be implemented in a Transcrypt SC20-DES Phoenix analog scrambler which has all the components of FIG. 1 except connections 41 and 42. This product uses the Data Encryption Standard (DES) as the cipher, and can be implemented with a Texas Instruments TMS320F206 digital signal processor to handle the processing requirements of DES as the cipher.

The primary use of the present invention is in an analog scrambler to provide a means for performing a cipher check. Other uses are obvious to those skilled in the art, based upon the description and advantages listed above.

Options and Alternatives

It will be appreciated that the present invention can take many forms and embodiments. The true essence and spirit of this invention are defined in the appending claims, and it is not intended that the embodiment of the invention presented herein should limit the scope thereof.

For example, block cipher 10 can be DES or some other encryption method that uses a IV or its equivalent. If DES is used, it could be in a variety of modes, including CFB or OFB. Connections 41 and 42 are DATA-IN and DATA-OUT connections on a conventional DSP. A cipher implemented in software, such as well-known in the art is operatively internal of DSP.

What is claimed:

1. An apparatus to secure analog signals comprising:
analog inputs to receive an analog source signal;
an analog scrambler connected to the analog inputs, and having an input for receiving a pseudo-random number stream for driving the scrambler;
a digital signal processor in which is implemented a digital cipher which operates as a pseudo-random number generator to create the pseudo-random number stream;
a digital input and output from external of the scrambler to the digital signal processor to allow digital communication with the digital signal processor.

2. The apparatus claim 1 wherein the scrambler comprising an audio or video scrambler.

3. The apparatus of claim 1 wherein the scrambler comprises a frequency modifier operating according to a rolling code.

4. The apparatus of claim 1 wherein the digital cipher is DES.

5. The apparatus of claim 1 wherein the digital cipher operates with a 64 bit initialization vector.

6. The apparatus of claim 1 further comprising a cipher check device operatively connected to digital input and output to the cipher for performing a cipher check directly to the digital cipher.

7. The apparatus of claim 1 further comprising an additional digital cipher component operatively connected to the digital input and output to provide an additional enciphering process for the generation of the pseudo-random number stream to allow greater security and randomness for the number stream.

8. The apparatus of claim 1 further comprising operatively connecting the digital input and output with a source of plaintext for digital encryption, to allow the apparatus to alternatively scramble an audio signal and encrypt a digital signal.

9. A method for cipher checking an analog scrambler carrying:
generating a pseudo-random number stream with a digital cipher;
driving an analog scrambler with the pseudo-random number stream;
directly accessing the digital cipher;
performing a cipher check through the direct access.
